(19) United States
(12) Patent Application Publication
(10) Pub. No.: US 2002/0068136 A1
(43) Pub. Date: Jun. 6, 2002

(54) Laminate sheeting for pouches

(76) Inventors: Arnold B. Finestone, West Palm Beach, FL (US); Gilbert Bloch, Palm Beach Gardens, FL (US)

Correspondence Address: WINSTON & STRAWN, 200 PARK AVENUE, NEW YORK, NY, 10166-4193, US

(21) Appl. No.: 10/038,293

(22) Filed: Jan. 2, 2002

Related U.S. Application Data
(63) Continuation-in-part of application No. 08/327,601, filed on Oct. 24, 1994.

(51) Int. Cl. B32B 1/08

(52) U.S. Cl. 428/34.3; 428/35.2; 428/35.3; 428/35.7; 428/35.9; 206/524.2

(57) ABSTRACT

A pouch or other container for forming an envelope protectively packaging a product such as a flowable or solid food substance. The pouch is fabricated from a laminate sheeting whose plies have different properties that depend on package requirements, at least one ply in the laminate being an oriented, synthetic plastic film of high tensile strength. The plies are adhesively interlaminated at ambient temperature with a water-based adhesive whereby the orientation of the film is unaffected by the laminating process, in the course of which no environmentally objectionable fumes are discharged into the atmosphere. The laminate may also be made into a water-resistant envelope or package for mailing various materials.

### CROSS REFERENCE TO RELATED APPLICATIONS

This application is a continuation-in-part of application Ser. No. 08/327,601, filed Oct. 24, 1994, the content of which is expressly incorporated herein by reference thereto.

### BACKGROUND ART

This invention relates generally to pouches or containers forming an envelope for protectively packaging food substances, written materials, and other products, and more particularly to a pouch fabricated of laminate sheeting, at least one ply of which is an oriented synthetic plastic film which imparts high strength and tear resistance to the pouch. This invention also relates to paper-plastic laminate sheeting capable of being converted into envelopes, bags and other dilatable container products which initially are in a flat state and are normally made of paper, and more particularly to a laminate sheeting in which two synthetic plastic sheets are either adhered together or adhered to an inner layer of a paper sheet.

Pouches or containers for storing and dispensing flowable or solid food substances and other more or less perishable products are usually fabricated of a multiply laminate sheeting forming an envelope to protect the contents of the package and prolong its shelf life. The shelf life of a packaged product depends on the degree to which it is isolated from the atmosphere in which the package is placed.

One well-known form of pouch serves to package a hot dog relish which is dispensed by tearing an opening in the pouch and then squeezing the pouch to extrude the relish therefrom. This pouch is formed of a laminate sheeting whose outer ply is a clear polyester film, the inner face of which is printed to identify the contents. The outer film ply is adhesively laminated to an intermediate ply of metal foil which in turn is adhesively laminated to an inner ply formed of polyethylene film.

The three plies which together create this laminate sheeting have distinctly different properties. The outer polyester film ply imparts strength and tear resistance to the pouch, the intermediate metal face ply acts as a moisture barrier, while the inner polyethylene ply facilitates sealing of the pouch.

The reason metal foil or a metallized plastic film is often included in laminate sheeting from which a pouch is fabricated to package food, is that plastic films, even those of exceptional tensile strength, have some degree of porosity. As a consequence, a pouch formed entirely of plastic film material will exhibit a moisture vapor transmission rate (MVTR) that is unsuitable in a food container. The transfer of moisture through the envelope of a food pouch reduces its shelf life, and a moisture barrier is therefore desirable.

A serious drawback of multi-ply laminate sheeting of the type heretofore used for fabricating pouches and other packaging material, does not entirely reside in the structure of the sheeting, but rather in the environmental conditions which prevail in the course of producing the sheeting.

Most industrial adhesives used to interlaminate the several plies of the laminate sheeting, include volatile chemical solvents which in the course of curing the adhesive are volatilized. The resultant noxious fumes which are driven off into the atmosphere are environmentally objectionable. It becomes necessary, therefore, in the plant in which the pouch laminate sheeting is produced, to provide filtration and other equipment to capture and treat the noxious fumes. This requirement adds substantially to the cost of production.

In those instances where hot melt adhesives are used to interlaminate the plies of the laminate sheeting, not only do some of these adhesives give off objectionable fumes, but the heat involved may have adverse effect on the plies to which the hot melt adhesive is applied. Thus, if one of the plies is a synthetic plastic film that has been uni-axially or bi-axially oriented to enhance its tensile strength, this orientation will be impaired by heat, for heat acts to relax the film and in doing so, to destroy its orientation.

Of background interest are the U.S. Pat. No. 4,790,429 to Fukushima, as well as U.S. Pat. Nos. 3,989,640 and 4,724,982 to Redmond which disclose various forms of pouches and containers for food products formed of plastic film material. The food pouch disclosed in U.S. Pat. No. 3,366,229 to Sanni uses a laminated sheeting of thermoplastic film and paper so that seal lines can be produced by thermal welding. U.S. Pat. No. 4,806,398 to Martin shows a carton for liquid formed by a paper substrate having bonded to one side a polyethylene film and to the other side a polyolefin film to provide a liquid-impermeable laminate that lends itself to thermal bonding. A similar container is shown in U.S. Pat. No. 3,404,988 to Rawing

There is also a need for materials that can be used for packaging or mailing of various items. In the past, such materials vary from Kraft paper, coated with polymers or plastic films. The polymer films or polymer coatings provide resistance to moisture, such as would be encountered from rain or snow during times when the package is being shipped.

The sheeting traditionally used in making packaging materials such as envelopes, grocery bags and other types of dilatable container products which initially are in a flat state, is paper. Paper is a semi-synthetic material made by chemically processing cellulose fibers. Apart from its low cost, an important advantage of paper is that it can be converted into envelopes and other types of dilatable container products by means of high speed equipment that functions to cut and fold the sheeting into the desired configuration, the folds and flaps of the product being bonded together, where necessary, by standard lowcost adhesives. Another advantage of paper in this context is that it can readily be printed and colored, using standard inks for this purpose. But such paper products suffer from several disadvantages, for they are characterized by low tear and burst strength, and are by no means water resistant; for unless coated, paper is highly absorbent.

Also well known in the art are plastic-coated cellulosic papers, these being used chiefly in children's books, posters, signs and shipping tags, and for other purposes demanding resistance to hard wear and to outdoor exposure. Such plastic-coated papers lack high tear and burst strength. Also low in strength are special purpose coated papers covered on one or both sides with a suspension of clays, starches, rosin or wax, or a combination of these substances. To overcome the drawbacks of paper-fabricated dilatable container products, in recent years such products have been made of TYVEC or other polymeric synthetic plastic sheeting. The resultant products not only have a tear and bursting strength far superior to paper, but they are also waterproof. TYVEC and similar synthetic plastic sheeting materials are difficult to convert into envelopes and other dilatable container products using high-speed equipment of the type mainly suitable for paper. As a consequence, production scrap rates can run as high as thirty percent, thereby raising the cost of manufacturing these products. Moreover, such plastic sheeting has a low chemical affinity for standard adhesives; hence in the case of envelopes, one must then use a special and more costly adhesive on the flaps. And such plastic sheeting also has a low affinity for standard printing inks, and the products, therefore, demand special printing inks for this purpose.

One particular packaging material that resolves some of these problems is disclosed in U.S. Pat. No. 5,244,702 to Bloch et al., where an envelope is made from a laminate of a plastic film that is adhesively cold laminated between two layers of paper. The paper layers enable the laminate to be printed, colored or marked with indicia, while the plastic film provides resistance to tearing and resistance to deterioration by contact with moisture or rough handling.

While the envelope material of the Bloch et al. patent is suitable for most applications, there are situations when greater moisture and tear resistance are required. The present invention now provides a new material that satisfies these needs.

### SUMMARY OF THE INVENTION

The present invention now provides a pouch or container forming an envelope for protectively packaging a food substance, an item to be mailed, or other products, the pouch being fabricated of a laminate sheeting of exceptional strength and moisture resistance. A significant advantage of a laminate sheeting in accordance with the invention is that in the course of its production during which the plies of the sheeting are adhesively interlaminated, with no environmentally objectionable fumes being emitted. It is therefore not necessary in a production plant to take measures to recover solvents or otherwise clean up the atmosphere.

More particularly, the invention provides a laminate sheeting for fabricating pouches to package food substances or other products in which at least one ply of the sheeting is formed by an oriented synthetic plastic film of high strength whose orientation is unimpaired in the course of interlamination of the plies. Preferably, a paper ply can be provided between the two plastic plies. Optionally, an additional paper ply can be provided on one or even both plastic film outer surfaces.

The pouch or other container forms an envelope for protectively packaging a product such as a flowable or solid food substance. It can also be used as a mailer or packaging material. The pouch is fabricated from a laminate sheeting whole plies have different properties that depend on package requirements, at least one ply in the laminate being an oriented, synthetic plastic film of high tensile strength. Preferably, both plastic films are oriented. The plies are adhesively interlaminated at ambient temperature with a water-based adhesive whereby the orientation of the film is unaffected by the laminating process, in the course of which no environmentally objectionable fumes are discharged into the atmosphere. A preferred way to do this is to laminate each plastic film to a side of a sheet or layer of paper.

### BRIEF DESCRIPTION OF THE DRAWINGS

For a better understanding of the invention as well as other objects and further features thereof, reference is made to the following detailed description to be read in conjunction with the accompanying drawings, wherein:

FIG. 1 is a perspective view of a preferred embodiment of a pouch in accordance with the invention;

FIG. 2 is a transverse section taken through the pouch in the plane indicated by line 2-2 in FIG. 1;

FIG. 3 is a section taken through the laminate sheeting from which the pouch is fabricated;

FIG. 4 is a section taken through a modified form of laminate sheeting; and

FIG. 5 schematically illustrates a system for producing the laminate sheeting.

FIG. 6 is a cross-sectional view of a laminate in accordance with the invention;

FIG. 7 shows, in schematic form, a system and method adapted to produce the laminate of FIG. 6; and

FIG. 8 shows the rear side of an envelope fabricated from the laminate.

### DETAILED DESCRIPTION OF THE PREFERRED EMBODIMENTS

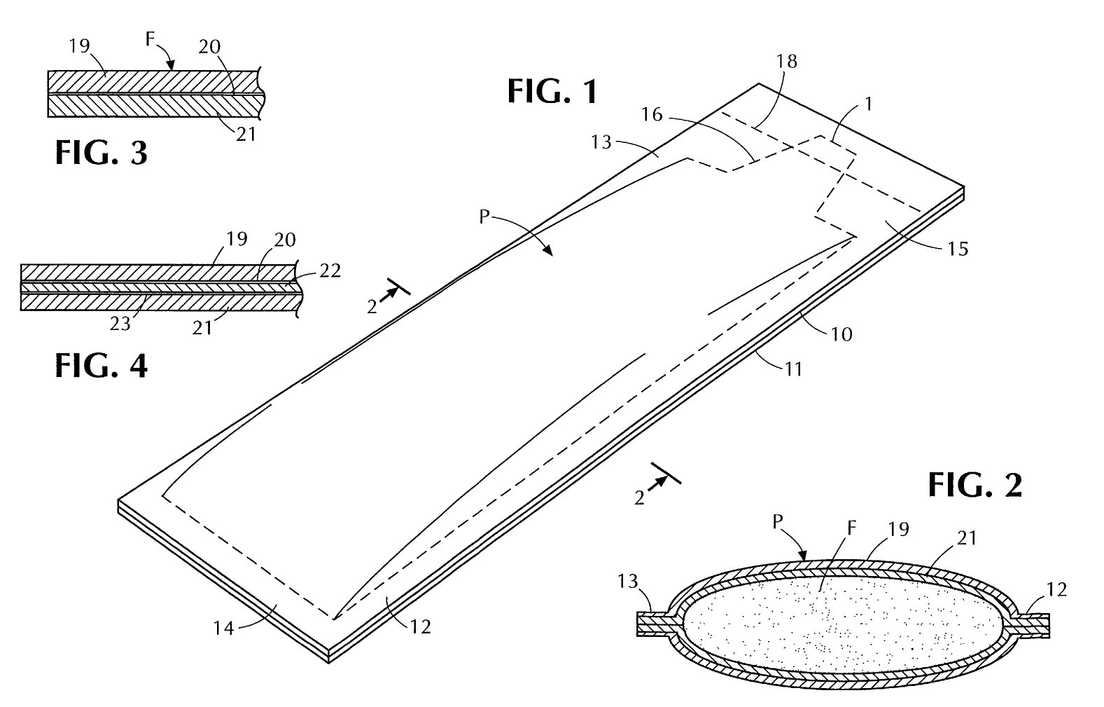

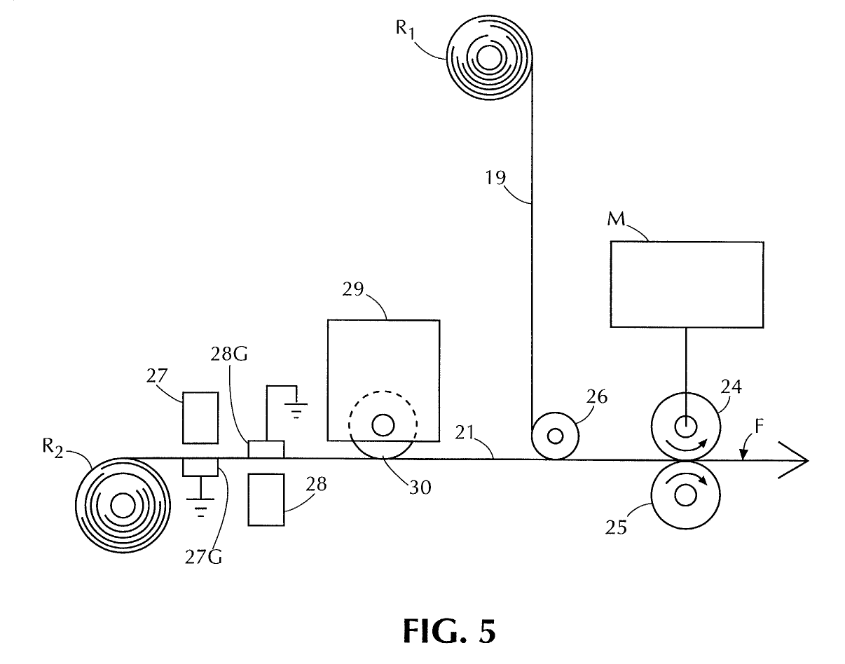

FIGS. 1 and 2 illustrate a pouch fabricated from two superposed rectangular panels 10 and 11 formed of a flexible laminate sheeting in accordance with the invention. The side margins 12 and 13 and the lower end margin 14 of the superposed panels are sealed together to create between these panels an expandable envelope or pocket P. In this embodiment, the pocket is fillable with a flowable food product F, such as mustard or ketchup.

The upper end section 15 of the pouch is so sealed as to define an interior spout 16 which communicates with pocket P and leads to a normally-sealed outlet 17. A weakened transverse tear line 18 is scored or perforated across the upper end section 15 to intersect the outlet 17.

Thus, all that is necessary to put the pouch to use is to tear off the end section along tear line 17, thereby opening outlet 17. Then by squeezing the pouch, the mustard or ketchup is extruded therefrom and discharged from the open outlet.

This pouch, though illustrative of a flexible container fabricated of laminate sheeting in accordance with the invention is by no means the only form of pouch that can be so produced. Thus, the pouch may be shaped and dimensioned to store potato chips, or candy and other solid food substances. Or the pouch or container formed of the laminate sheeting may be designed to envelop and protectively package small toys and other non-food products which are more or less perishable.

FIG. 3 illustrates the structure of the laminate sheeting F from which panels 10 and 11 of the pouch are derived. Sheeting F is a two ply laminate whose outer ply 19 is a film of synthetic plastic material biaxially or uniaxially oriented to enhance its tensile strength, thereby increasing the tear resistance of the pouch. In practice the film may have a thickness of no more than 2 mils.

Outer ply 19 is cold laminated by a layer 20 of water-based adhesive to an inner ply 21 of a synthetic plastic film material such as polyvinyl chloride whose tensile strength is not as great as that of the outer ply, but whose properties are such that the film is compatible and non-reactive with the food contents of the pouch and lends itself to sealing. Thus, when at the margins 12 and 13 of the pouch, the inner ply 21 of the upper panel 10 engages the inner ply 21 of the lower panel 11 of the same film material, these margins may be sealed together by pressure and heat at a temperature sufficient to fuse these plies.

To this end, the upper ply 19 should have a high glass transition temperature (the temperature at which a polymer changes from a vitreous to a softened plastic state), while the inner ply 21 should have a lower glass transition temperature. Thus, when the margins of the superposed laminate panels are subjected to heat and pressure by sealing bars, only the pressed together inner plies of the panels will fuse together and the outer plies will be unaffected by the heat. Film materials suitable for outer ply 19 of the laminate are polypropylene, polyethylene, nylon or a polyester such as MYLAR. The tensile strength of a synthetic plastic film is substantially increased by orientation which results in molecular orientation of the film material. In the case of biaxial orientation, orientation is in both the longitudinal and transverse directions. This is usually effected by controlled stretching of the unoriented film.

Lamination of outer ply 19 to inner ply 21 is effected at ambient temperature by water-based adhesive 22 which is preferably a polyacrylic copolymer composition having an affinity for both plies. A water-based adhesive when cured, is not soluble in water and cannot be remoistened. Because the water-based adhesive is fluid at ambient temperature and is not a hot melt adhesive, no heat is applied to the biaxially-oriented film as it is being laminated to the inner ply; hence cold lamination is effected.

It is important to bear in mind that an oriented film is heat-sensitive, and that at elevated temperatures, the film relaxes and loses its molecular orientation and tensile strength. Cold lamination at ambient temperature is therefore essential to the present invention in order to produce a pouch of high tear and burst strength.

It is also to be noted that a synthetic plastic film material, such as polypropylene, is normally not receptive to adhesives, especially water-based adhesives. Hence if one were to apply to the surface of this film a water-based adhesive which is flowable at ambient temperature or at a temperature somewhat above ambient but not at the elevated temperature of a hot melt adhesive, this adhesive will not be adsorbed by the film. Essential to the invention is that the opposing surfaces of the film be treated so as to render them wettable and hence receptive to adhesives, as well as to standard printing inks. To this end, these surfaces are subjected to a corona discharge ionizing treatment which enhances their surface energy, as measured in dynes, and thereby renders them wettable to allow for better bonding of adhesives applied thereto. And the exposed surface of the outer ply 19 may be printed to identify the product in the envelope and its maker.

It is important that the surfaces of the films be subjected to a corona-discharge treatment shortly before the adhesive is applied thereto, for the effect of such treatment has a relatively short duration. This conveniently is achieved by placing the adhesive application immediately downstream of the corona discharge electrode which is used to treat the film. Thereafter the adhesive carrying plastic film contacts a second corona discharge treated film immediately before press rollers which laminate the films together. It is helpful to allow the adhesive carrying film to run for a sufficient distance to allow some of the moisture to evaporate from the adhesive before it is laminated to the other film.

In another embodiment, an intermediate paper layer is used to absorb some of the water from the adhesive to accelerate the cure time for the adhesive. In this embodiment, the adhesive containing corona discharge treated film is laminated to the paper layer by passing through a first set of press rolls to form a paper-plastic laminate. This paper side of laminate then contacts a second plastic film that is corona discharge treated and applied with adhesive. The two materials are brought together and passed through a second set of press rolls to form a final plastic-paper-plastic laminate. This laminate can be used to prepare an envelope or pouch that can be used for mailing various items. The outer plastic layers provide resistance to moisture while the inner plastic film provides a smooth surface for introducing items into the pouch or envelope. The inner paper layer can be preprinted with written material, colors, or other indicia on one or both sides so that information regarding the origination or mailer of the package or its manufacturer can be readily observed. The paper layer can also be metallized on one or both sides for an enhanced appearance.

There may be certain situations where it is undesirable to have exposed interior or exterior plastic surfaces. These situations can be avoided by laminating additional paper layers to one or both of the exposed surfaces of the plastic films. These additional paper layers can be applied as described above with any of the laminates disclosed herein to thus provide final laminates of paper-plastic-plastic; paper-plastic-plastic-paper; paper-plastic-paper-plastic; or paper-plastic-paper-plastic-paper. This demonstrates the versatility of the invention in providing the most desirable form of the laminate for any particular use.

The salient advantages of the laminate in accordance with the invention include the waterproof properties of the resulting laminate, and the fact that the laminate can be converted into products by conventional equipment for this purpose with minimum scrap in a range in a range comparable to the scrap rate encountered in making paper envelopes and other dilatable container products. As paper sheets have a high affinity for standard printing inks, when these are included, the resulting laminate can readily be printed and colored. Also, when a paper layer or sheet is provided on the exterior surfaces, a standard starch or pressure-sensitive adhesive may be used on the flaps of envelopes formed of these laminates.

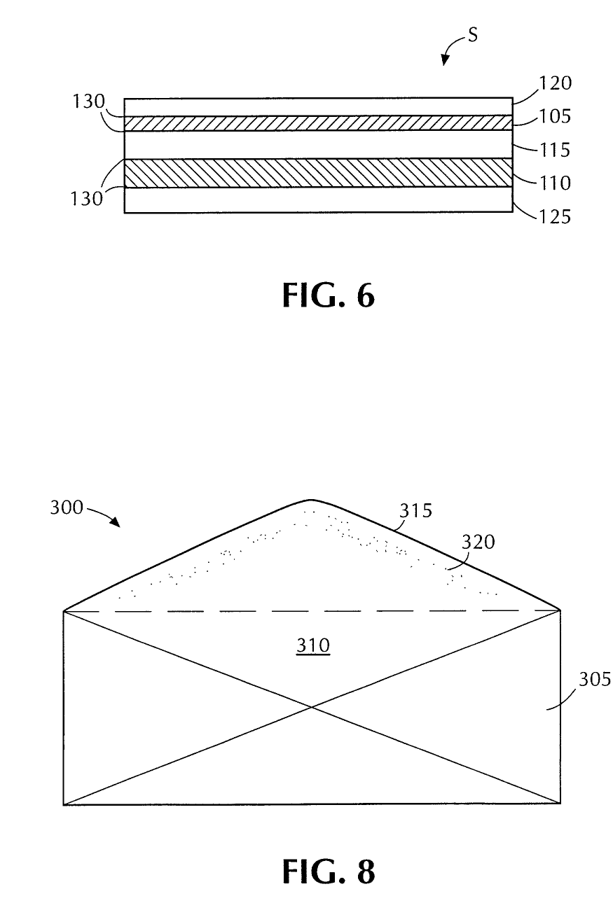

Referring now to FIG. 6, shown therein in cross-section and on an enlarged scale is a flexible plastic-paper-plastic sheeting S in accordance with the invention. The laminate of this figure is illustrated with additional, optional layers or plies that are taught by the invention. The laminate includes plastic layers 105, 110, which are mandatory, intermediate paper layer 115, and outer paper layers, 120, 125. Each of the paper layers is optional. As noted above, in the most basic embodiment, the two plastic layers are treated on their opposed surfaces with a corona discharge to increase the surface energy and render these surfaces receptive to adhesives. Thereafter, a water-based adhesive is applied and the layers are cod laminated together.

In a first variation of this, the intermediate paper layer 115 is provided. This layer absorbs some of the moisture from the water-based adhesive to facilitate drying and curing of the laminate. Also, the paper can be painted, colored, or metallized on either side to provide an enhanced appearance to the laminate.

Optionally, the laminate can include one or more additional paper layers 120, 125, whose gauge, weight and quality are appropriate to the end use for which the laminate is intended. Thus if the end use is in a high strength grocery bag, the outer paper sheet may then be of good quality, unbleached Kraft paper, whereas if the end use is an envelope, then a white or colored paper appropriate to the intended type of the envelope can be included as the outer layer(s) of the laminate. In some cases, as where the product to be produced is an attractive shopping bag of high quality, outer sheets of coated or metallized paper sheets may be used for this purpose.

Both plastic films 105, 110, are cold-laminated by an adhesive layer to the interior paper sheet 115. Preferably, as noted above, these plastic films or layers 105, 110 are made of synthetic plastic material which is preferably transparent and is uniaxially or biaxially-oriented. Film materials suitable for this purpose are polypropylene, polyethylene, nylon or a polyester such as MYLAR.

The tensile strength of a synthetic plastic film is substantially increased by orientation which results in molecular orientation of the film. In the case of biaxial orientation, orientation is in both the longitudinal and transverse directions. This is usually effected by controlled stretching of the unoriented film. The tensile strength of an oriented film is seriously impaired if heat is applied thereto, for the heat acts to relax the film and cause it to lose its molecular orientation. Thus when biaxially oriented Mylar film panels are superposed and sealed together by heat and pressure applied along a line running along the panels, the film may then be easily torn along this line. This is the reason why in the present invention the use of hot melt adhesives to laminate the oriented plastic films to the paper sheet is interdicted; for to do so would seriously diminish the reinforcing characteristics of the film.

In the present invention, the plastic films are cold laminated to the paper sheet under pressure and at room temperature by means of a water-based polyacrylate copolymer adhesive, or by any other water-based adhesive having similar bonding properties and having an affinity both for the paper sheet and the plastic film. Since paper tends to absorb water in the laminating process, before the paper sheet 115 and the first plastic film 105 are together fed into pressure rolls and subjected to pressure to effect lamination, the inner surface of the film is first coated with the water-based adhesive which does not encounter the inner surface of the paper sheet until these two surfaces meet in the pressure rolls. In this way, the period during which absorption of the adhesive into the interior of the paper sheet can take place is limited. And to render the inner surface of the film more receptive to the water-based adhesive applied thereto, it is preferably first subjected to ionization to enhance the dynes on this surface. The same procedure is used to laminate the second plastic film 110 to the paper-plastic laminate produced by laminating paper sheet 115 to the first plastic film 105. Finally, the outer paper layer(s) 120 and/or 125 are cold laminated to the previously formed laminate in the same manner.

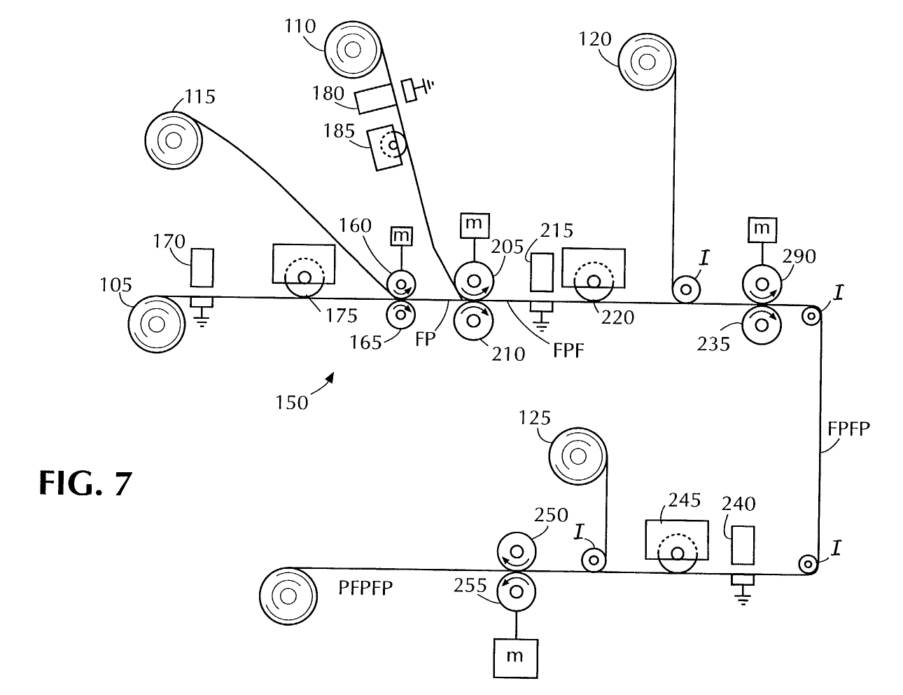

FIG. 7 illustrates a system 150 for carrying out a preferred technique for effecting cold lamination of the paper sheet and the oriented plastic film to produce the laminate. The system includes a first combining station having a pair of cooperating pressure rolls 160 and 165 driven at high speed by a motor M. The nip between the rolls is related to the thickness of the layers to be laminated and is adjusted to provide the required degree of laminating pressure to ensure secure bonding of the webs. Fed concurrently into the nip of the pressure rolls is a web of paper 115 drawn from a supply reel, and a web of plastic film also drawn from a supply reel.

Before entering the nip of the pressure rollers, film 105 is exposed to an ionization bar 170 which finctions to ionize the surface of film to increase the dynes of the surface preparatory to the application of a water-based adhesive thereto. Then a coating of a water-based adhesive is applied onto the surface of film by means of an adhesive applicator 175. It is not essential that the coating fully cover this surface, for in practice the roll of the adhesive applicator may take the form of a series of rings to apply parallel strips, dots or dashes of adhesive to the surface of the film. Hence, when the adhesive-coated plastic film and paper together enter the combining station and are subjected to pressure by pressure rolls 160 and 165, lamination is effected by this action to form a paper-plastic laminate FP.

At the same time, a second plastic film 110 is being exposed to an ionization bar 180 to energize its surface, and then a water-based adhesive is applied thereto by adhesive applicator 185, which applies a continuous or discontinuous adhesive thereupon. This adhesive coated plastic film faces the paper and is fed together with the paper-plastic laminate into a second combining station that has a second pair of cooperating pressure rollers 205, 210, driven by a motor M. This forms a plastic-paper-plastic laminate FPF.

The resulting three-ply plastic-paper-plastic laminate then passes by another ionization bar 215 which ionizes the outer surface of the plastic film 105. Subsequently, adhesive is applied to the activated film using applicator 220 in the same manner as described above, and the adhesive-coated film and paper layer 120, provided from a supply roll, now together enter into a third combining station having cooperating pressure rolls 230, 235. The various laminates are guided by idler rollers I as necessary. The resulting four-ply laminate FPFP has exterior paper layer, and may now be used in exactly the same manner as a reel of ordinary paper as the stock roll for standard equipment adapted to fabricate envelopes, bags or other dilatable paper products, by slitting, folding and whatever other operations are dictated by the form of the product.

In some applications, a five-ply paper-plastic-paper plastic-paper laminate PFPFP may be desirable. In this laminate, paper sheet 125 is cold-laminated to the opposite side of the oriented plastic film 105 of the FPFP laminate. The film 105 is exposed to ionizing bar 240 and adhesive applicator 245 before entering a fourth combining station with cooperating pressure rolls 250, 255. The final product is a five-ply laminate PFPFP which is collected on a take up roll 275 for transport to envelope making machines.

A problem encountered with four-ply paper-film laminate is that it tends to curl because of the dissimilar properties of the plies. Such curling is not desirable in products such as envelopes, though it may not be objectionable in other products. When the oriented film plies are sandwiched between two like plies of paper, the resultant five-ply laminate has symmetry which avoids the problem of curling.

The five-ply laminate has another important advantage, for now both outer exposed surfaces are paper. This makes it possible when the laminate is converted in standard equipment for this purpose into an envelope or grocery bag in which the sheeting is slit and folded to form flaps or other elements which must be sealed together, to use conventional, commercially available adhesives for this purpose, rather than the special adhesives that would be dictated if the surfaces to be sealed together included a plastic film surface. As all exposed surfaces of the laminate are paper, they can be readily printed.

As explained above, the paper layers are optional, so that different embodiments can be made by omitting one or more of paper layers 115, 120 and 125. The resulting products can beremoved from the line after the desired laminations are made, such as at the points where laminates FP, FPF, or FPFP are formed. Of course, the elimination of paper layer 115 would produce a film-film laminate at point FPF. Thus a versatile laminate producing sstem is provided by the arrangement of FIG. 7.

An example of a product fabricated from a five-ply laminate in accordance with the invention is shown in FIG. 8, this being an envelope 300. The envelope 300 has the form of a conventional paper envelope, except that its exterior surface 305 is one paper facing sheet component of the laminate and its interior surface 310 is the other paper component thereof, the films and interior paper plies being sandwiched between the outer paper layers. The flap 315 of the envelope is provided with an adhesive band 320 which may be a standard starch adhesive or a pressure-sensitive adhesive.

While embodiments of the invention have been shown and described, it will be appreciated that many changes may be made therein without departing from the spirit of the invention. For example, the plastic films themselves can be colored or clear. Coloration of the films can be made over the entire film or only on selective portions. Metallization of the films can be provided in the same manner. When clear plastic films are utilized in a plastic-plastic laminate, the contents of the envelope or pouch are visible so that the recipient can readily determine what is included therein. This can be used for safety or quality control purposes.

What is claimed is:

1. A pouch or container for forming an envelope to protectively package a product or item therein, said envelope being fabricated of a laminate sheeting comprising:
an outer ply of oriented synthetic plastic film having at least one surface that is corona-discharge treated to render it wettable and receptive to adhesives and printing inks;
an inner ply of synthetic plastic film having at least one surface that is corona-discharge treated to render it wettable and receptive to adhesives and printing inks; and
a water-based adhesive;
wherein the corona-discharge treated surfaces are adhesively cold laminated together by the adhesive to produce a laminate having high tensile strength, moisture resistance and teat resistance.

2. A pouch as set forth in claim 1, further comprising a paper ply that is adhesively laminated by a water-based adhesive to the outer corona-discharge treated surfaces of the inner and outer plies at ambient temperature to produce a plastic-paper-plastic laminate.

3. A pouch as set forth in claim 1, in which the outer ply film is metallized to provide a moisture barrier.

4. A pouch as set forth in claim 1, in which a metal foil intermediate ply is sandwiched between the outer ply and the inner ply and is cold laminated thereto.

5. A pouch as set forth in claim 1, in which the outer or inner film plies are formed of a polyester film, a polyethylene film, or a polypropylene film.

6. A pouch as set forth in claim 1, in which the outer film ply has a glass transition temperature that is higher than that of the inner film ply.

7. A pouch as set forth in claim 1, in which the envelope is formed by two superposed panels of said laminate sheeting which are marginally sealed together to define a pocket to accommodate the product.

8. A pouch as set forth in claim 1, in which the panels are sealed together to define a spout communicating with the pocket and leading to an outlet.

9. A pouch as set forth in claim 2, in which the outer surface of the outer ply is corona discharge treated to render it wettable to adhesives, and further comprising a paper sheet which is adhesively cold laminated to the outer surface of the outer ply.

10. A pouch as set forth in claim 9, in which the outer surface of the inner ply is corona discharge treated to render it wettable to adhesives, and further comprising a paper sheet which is adhesively cold laminated to the outer surface of the inner ply.

11. A pouch as set forth in claim 1, in which the adhesive is an acrylic copolymer or a polyacrylate copolymer.

12. A flexible plastic-paper-plastic laminate capable of being converted by conventional equipment into envelopes, bags and other dilatable container products normally made of paper which initially are in a flat state, said sheeting comprising:
a printable paper sheet having inside and outside surfaces;
a first reinforcing film of synthetic oriented plastic material having an inner surface treated to increase its dynes and its affmity to adhesives and being cold-laminated by a water-based adhesive to the inside surface of the paper sheet; and
a second reinforcing film of synthetic oriented plastic material having an inner surface treated to increase its dynes and its affinity to adhesives and being cold-laminated by a water-based adhesive to the outside surface of the paper sheet;
whereby the product made from the sheeting has moisture resistance and exceptional tear and burst strength.

13. A laminate sheeting as set forth in claim 12, wherein each film is biaxially oriented.

14. A laminate sheeting as set forth in claim 12, wherein said water-based adhesive is an acrylic polymer or a polyacrylate copolymer.

15. A laminate sheeting as set forth in claim 12, wherein each film is formed of polyester, polypropylene or polyethylene.

16. A laminate sheeting as set forth in claim 12, wherein the paper sheet is formed by Kraft paper or white paper.

17. A laminate sheeting as set forth in claim 12, wherein an outer surface of one of the plastic films is surface treated to increase its dynes and its affinity to adhesives prior to lamination and further comprising a facing sheet of paper cold laminated to the treated outer surface of the plastic film.

18. A laminate sheeting as set forth in claim 17, wherein the paper sheet is formed of coated paper.

19. A laminate sheeting as set forth in claim 17, wherein an outer surface of the other plastic film is surface treated to increase its dynes and its affinity to adhesives prior to lamination and further comprising a facing sheet of paper cold laminated to the treated outer surface of the other plastic film.

20. A laminate sheeting as set forth in claim 19, wherein the second paper sheet is formed of coated paper.
